(19) United States
(12) Patent Application Publication
(10) Pub. No.: US 2011/0015765 A1
(43) Pub. Date: Jan. 20, 2011

(54) CONTROLLING AN AUDIO AND VISUAL EXPERIENCE BASED ON AN ENVIRONMENT

(75) Inventors: Allen P. Haughay, JR., Morgan Hill, CA (US); Michael Ingrassia, San Jose, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 12/503,741

(22) Filed: Jul. 15, 2009

(51) Int. Cl. G06F 17/00; G06T 11/20

(52) U.S. Cl. 700/94; 345/440

(57) ABSTRACT

Systems and methods for controlling an audio and visual experience based on an environment are provided. A system can monitor an environment while playing back music. The system can then identify a characteristic property of the environment and modify an audio-related or visual-related operation based on the characteristic property. The characteristic property can be any suitable property of the environment or any combination thereof. For example, the characteristic property can be related to an ambient property of the environment (e.g., light or sounds) or the environment's occupants (e.g., number of people nearby). The system can then modify its operation in any suitable manner based on the characteristic property. For example, the system can provide a visualization of music based on at least the characteristic property. In another example, the system can select and play back a piece of music based on at least the characteristic property.

### BACKGROUND OF THE INVENTION

This is directed to controlling audio and visual outputs. In particular, this is directed to systems and methods for controlling audio and visual outputs based on an environment.

Some traditional electronic devices allow a user to control audio and visual output. For example, a traditional device may allow a user to select several songs for a playlist and enable a visualizer for providing a visualization of the music. However, such traditional playlists are typically static and traditional visualizers are based on the configuration specified by the user and the audio content of the music. Accordingly, the audio and visual output provided by a traditional device can be completely inappropriate for the device's environment.

### SUMMARY OF THE INVENTION

This is directed to systems and methods for controlling an audio and visual experience based on an environment. A system can monitor an environment while playing back music. The system can then identify a characteristic property of the environment and modify an audio-related or visual-related operation based on the characteristic property. The characteristic property can be any suitable property of the environment or any combination thereof. For example, the characteristic property can be related to an ambient property of the environment (e.g., light or sounds) or the environment's occupants (e.g., number of people nearby or characteristics of people nearby). After identifying the characteristic property, the system can modify an audio-related or visual-related operation in any suitable manner based on the characteristic property. For example, the system can modify a visual-related operation by providing a visualization of the music based on at least the characteristic property. In another example, the system can modify an audio-related operation by selecting a piece of music based on at least the characteristic property and then playing back the selected music. Accordingly, a system can control an audio and visual experience based on its environment.

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is a schematic view of an illustrative electronic device for controlling an audio and visual experience in accordance with one embodiment of the invention;

FIG. 2 is a schematic view of an illustrative system for controlling an audio and visual experience in accordance with one embodiment of the invention;

FIG. 3 is a flowchart of an illustrative process for controlling an audio and visual experience in accordance with one embodiment of the invention;

FIG. 4 is a schematic view of an illustrative display for providing a visualization of music in accordance with one embodiment of the invention;

FIG. 5 is a flowchart of an illustrative process for providing a visualization of music in accordance with one embodiment of the invention;

FIG. 6 is a schematic view of an illustrative display for configuring a system to provide a visualization of music in accordance with one embodiment of the invention;

FIG. 7 is a schematic view of an illustrative display for configuring a system to provide a visualization of music in accordance with one embodiment of the invention;

FIG. 8 is a schematic view of an illustrative display for selecting a piece of music in accordance with one embodiment of the invention;

FIG. 9 is a flowchart of an illustrative process for selecting a piece of music in accordance with one embodiment of the invention; and

FIG. 10 is a schematic view of an illustrative display for configuring a system to select a piece of music in accordance with one embodiment of the invention.

### DETAILED DESCRIPTION

This is directed to systems and methods for controlling audio and visual experiences based on an environment. A system can control an audio and visual experience by modifying its operation in any suitable manner. For example, a system can modify its operation by providing a visualization of music, selecting songs for playback, controlling an audio and video experience in any other suitable manner, or any combination thereof. In some embodiments, a system can control an audio and visual experience by modifying its operation in response to a change in the environment. In some embodiments, a user can configure a system to specify how an audio and visual experience may be controlled based on the environment. For example, a user can specify what aspects of a system's operation may change in response to a change in a characteristic property of the environment.

To obtain information about an environment, a system can monitor the environment. In some embodiments, monitoring the environment can include receiving a signal from any suitable sensor or circuitry. For example, a system can monitor an environment by receiving a signal from an accelerometer, camera, microphone, magnetic sensor, thermometer, hygrometer (e.g., a humidity sensor), physiological sensor, any other suitable sensor or circuitry, or any combination thereof. In some embodiments, a system can monitor an environment by receiving a signal from a user (e.g., a user input). For example, a system can monitor an environment by receiving a user input that represents one or more conditions of the environment. In some embodiments, a system can monitor an environment by receiving a signal from one or more devices. For example, a system can receive a signal from one or more devices through a communications network.

Monitoring the environment can include identifying one or more characteristic properties of the environment. For example, a system can analyze a received signal to identify a characteristic property of the environment. A characteristic property can include any suitable property of the environment. In some embodiments, a characteristic property may be based on a ambient property of the environment, such as vibrations, light (e.g., ambient light levels or average color), sound, magnetic fields, temperature, humidity, barometric pressure, any other suitable ambient property or any combination thereof. In some embodiments, a characteristic property may be based on an environment's occupants, such as the people or devices in the environment. For example, a characteristic property can be based on the number of people or devices in an environment, the movement of people or devices in an environment, characteristics of people or devices in an environment, any other feature of the environment's occupants, or any combination thereof.

A system can then control an audio and visual experience based on the characteristic property. For example, a system can determine the average color of an environment (e.g., a characteristic property) and provide a visualization of music with a color based on the average color. In another example, a system can determine the average speed of people moving in an environment (e.g., a characteristic property) and then select and play a song based on the average speed. Accordingly, systems and methods described herein can provide contextually appropriate audio and visual experiences.

A system for controlling audio and visual experiences based on an environment can include any number of devices. In some embodiments, a system can include multiple devices. For example, monitoring the environment can include receiving signals from several devices in a network and then one or more devices can be used to control an audio and visual experience. In some embodiments, a system can include a single device. For example, a single device can both monitor the environment and control an audio and visual experience.

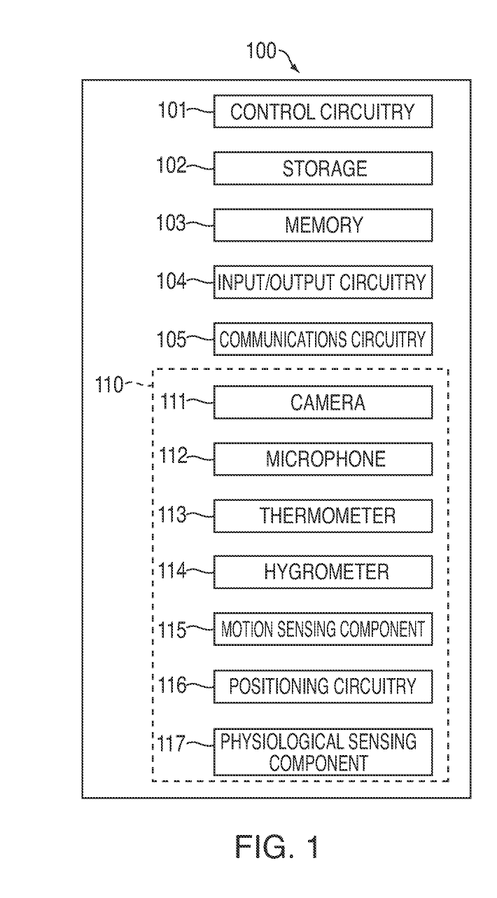

FIG. 1 is a schematic view of an illustrative electronic device for controlling an audio and visual experience in accordance with one embodiment of the invention. Electronic device 100 can include control circuitry 101, storage 102, memory 103, input/output circuitry 104, communications circuitry 105, and one or more sensors 110. In some embodiments, one or more of the components of electronic device 100 can be combined or omitted. For example, storage 102 and memory 103 can be combined into a single mechanism for storing data. In some embodiments, electronic device 100 can include other components not combined or included in those shown in FIG. 1, such as a power supply (e.g., a battery or kinetics), a display, a bus, or an input mechanism. In some embodiments, electronic device 100 can include several instances of the components shown in FIG. 1 but, for the sake of simplicity, only one of each of the components is shown in FIG. 1.

Electronic device 100 can include any suitable type of electronic device operative to play back music. For example, electronic device 100 can include a media player such as an iPod® available by Apple Inc., of Cupertino, Calif., a cellular telephone, a personal e-mail or messaging device (e.g., a Blackberry® or a Sidekick®), an iPhone® available from Apple Inc., pocket-sized personal computers, personal digital assistants (PDAs), a laptop computer, a cyclocomputer, a music recorder, a video recorder, a camera, and any other suitable electronic device. In some cases, electronic device 100 can perform a single function (e.g., a device dedicated to playing music) and in other cases, electronic device 100 can perform multiple functions (e.g., a device that plays music, displays video, stores pictures, and receives and transmits telephone calls).

Control circuitry 101 can include any processing circuitry or processor operative to control the operations and performance of an electronic device of the type of electronic device 100. Storage 102 and memory 103, which can be combined can include, for example, one or more storage mediums or memory used in an electronic device of the type of electronic device 100. In particular, storage 102 and memory 103 can store information related to monitoring an environment such as signals received from a sensor or another device or a characteristic property of the environment derived from a received signal. Input/output circuitry 104 can be operative to convert (and encode/decode, if necessary) analog signals and other signals into digital data, for example in any manner typical of an electronic device of the type of electronic device 100. Electronic device 100 can include any suitable mechanism or component for allowing a user to provide inputs to input/output circuitry 104, and any suitable circuitry for providing outputs to a user (e.g., audio output circuitry or display circuitry).

Communications circuitry 105 can include any suitable communications circuitry operative to connect to a communications network and to transmit communications (e.g., voice or data) from device 100 to other devices within the communications network. Communications circuitry 105 can be operative to interface with the communications network using any suitable communications protocol such as, for example, Wi-Fi (e.g., a 802.11 protocol), Bluetooth®, radio frequency systems (e.g., 900 MHz, 1.4 GHz, and 5.6 GHz communication systems), cellular networks (e.g., GSM, AMPS, GPRS, CDMA, EV-DO, EDGE, 3GSM, DECT, IS-136/TDMA, iDen, LTE or any other suitable cellular network or protocol), infrared, TCP/IP (e.g., any of the protocols used in each of the TCP/IP layers), HTTP, BitTorrent, FTP, RTP, RTSP, SSH, Voice over IP (VOIP), any other communications protocol, or any combination thereof. In some embodiments, communications circuitry 105 can be operative to provide wired communications paths for electronic device 100.

In some embodiments, communications circuitry 105 can interface electronic device 100 with an external device or sensor for monitoring an environment. For example, communications circuitry 105 can interface electronic device 100 with a network of cameras for monitoring an environment. In another example, communications circuitry 105 can interface electronic device 100 with a motion sensor attached to or incorporated within a user's body or clothing (e.g., a motion sensor similar to the sensor from the Nike+iPod Sport Kit sold by Apple Inc. of Cupertino, Calif. and Nike Inc. of Beaverton, Oreg.).

Sensors 110 can include any suitable circuitry or sensor for monitoring an environment. For example, sensors 110 can include one or more sensors integrated into a device that can monitor the device's environment. Sensors 110 can include, for example, camera 111, microphone 112, thermometer 113, hygrometer 114, motion sensing component 115, positioning circuitry 116, and physiological sensing component 117. A system can use one or more of sensors 110, or any other suitable sensor or circuitry, to determine a characteristic property of an environment and then modify its operation based on the characteristic property.

Camera 111 can be operative to detect light in an environment. In some embodiments, camera 111 can be operative to detect the average intensity or color of ambient light in an environment. In some embodiments, camera 111 can be operative to detect visible movement in an environment (e.g., the collective movement of a crowd). In some embodiments, camera 111 can be operative to capture digital images. Camera 111 can include any suitable type of sensor for detecting light in an environment. In some embodiments, camera 111 can include a lens and one or more sensors that generate electrical signals. The sensors of camera 111 can be provided on a charge-coupled device (CCD) integrated circuit, for example. Camera 111 can include dedicated image processing circuitry for converting signals from one or more sensors to a digital format. Camera 111 can also include circuitry for pre-processing digital images before they are transmitted to other circuitry within device 100.

Microphone 112 can be operative to detect sound in an environment. In some embodiments, microphone 112 can be operative to detect the level of ambient sound (e.g., crowd noise) in an environment. In some embodiments, microphone 112 can be operative to detect a crowd's noise level. Microphone 112 can include any suitable type of sensor for detecting sound in an environment. For example, microphone 112 can be a dynamic microphone, condenser microphone, piezoelectric microphone, MEMS (Micro Electro Mechanical System) microphone, or any other suitable type of microphone.

Thermometer 113 can be operative to detect temperature in an environment. In some embodiments, thermometer 113 can be operative to detect the air temperature of an environment. Thermometer 113 can include any suitable type of sensor for detecting temperature in an environment.

Hygrometer 114 can be operative to detect humidity in an environment. In some embodiments, hygrometer 114 can be operative to detect the relative humidity of an environment. Hygrometer 114 can include any suitable type of sensor for detecting humidity in an environment.

Motion sensing component 115 can be operative to detect movements of electronic device 100. In some embodiments, motion sensing component 115 can be operative to detect movements of device 100 with sufficient precision to detect vibrations in the device's environment. In some embodiments, the magnitude or frequency of such vibrations may be representative of the movement of people in the environment. For example, each person may be dancing and their footfalls may create vibrations detectable by motion sensing component 115. Motion sensing component 115 can include any suitable type of sensor for detecting the movement of device 100. In some embodiments, motion sensing component 115 can include one or more three-axes acceleration motion sensing components (e.g., an accelerometer) operative to detect linear acceleration in three directions (i.e., the x or left/right direction, the y or up/down direction, and the z or forward/backward direction). As another example, motion sensing component 115 can include one or more two-axis acceleration motion sensing components which can be operative to detect linear acceleration only along each of x or left/right and y or up/down directions (or any other pair of directions). In some embodiments, motion sensing component 115 can include an electrostatic capacitance (capacitance-coupling) accelerometer that is based on silicon micro-machined MEMS (Micro Electro Mechanical Systems) technology, a piezoelectric type accelerometer, a piezoresistance type accelerometer, or any other suitable accelerometer.

Positioning circuitry 116 can be operative to determine the current position of electronic device 100. In some embodiments, positioning circuitry 116 can be operative to update the current position at any suitable rate, including at relatively high rates to provide an estimation of movement (e.g., speed and distance traveled). Positioning circuitry 116 can include any suitable sensor for detecting the position of device 100. In some embodiments, positioning circuitry 116 can include a global positioning system (“GPS”) receiver for accessing a GPS application function call that returns the geographic coordinates (i.e., the geographic location) of the device. The geographic coordinates can be fundamentally, alternatively, or additionally derived from any suitable trilateration or triangulation technique. For example, the device can determine its location using various measurements (e.g., signal-to-noise ratio (“SNR”) or signal strength) of a network signal (e.g., a cellular telephone network signal) associated with the device. For example, a radio frequency (“RF”) triangulation detector or sensor integrated with or connected to the electronic device can determine the approximate location of the device. The device's approximate location can be determined based on various measurements of the device's own network signal, such as: (1) the angle of the signal's approach to or from one or more cellular towers, (2) the amount of time for the signal to reach one or more cellular towers or the user's device, (3) the strength of the signal when it reaches one or more towers or the user's device, or any combination of the aforementioned measurements, for example. Other forms of wireless-assisted GPS (sometimes referred to herein as enhanced GPS or A-GPS) can also be used to determine the current position of electronic device 100. Instead or in addition, positioning circuitry 116 can determine the location of the device based on a wireless network or access point that is in range or a wireless network or access point to which the device is currently connected. For example, because wireless networks have a finite range, a network that is in range of the device can indicate that the device is located in the approximate geographic location of the wireless network.

Physiological sensing component 117 can be operative to detect one or more physiological metrics of a user. In some embodiments, physiological sensing component 117 may be operative to detect one or more physiological metrics of a user operating device 100. Physiological sensing component 117 can include any suitable sensor for detecting a physiological metric of a user. Physiological sensing component 117 can include a sensor operative to detect a user's heart rate, pulse waveform, breathing rate, blood-oxygen content, galvanic skin response, temperature, heat flux, any other suitable physiological metric, or any combination thereof. For example, physiological sensing component 117 can include a heart rate sensor, a pulse waveform sensor, a respiration sensor, a galvanic skin response sensor, a temperature sensor (e.g., an infrared photodetector), an optical sensor (e.g., a visible or infrared light source and photodetector), any other suitable physiological sensor, or any combination thereof. In some embodiments, physiological sensing component 117 may include one or more electrical contacts for electrically coupling with a user's body. Such sensors can be exposed to the external environment or disposed under an electrically, optically, and/or thermally conductive material so that the contact can obtain physiological signals through the material. A more detailed description of suitable components for detecting physiological metrics with electronic devices can be found in U.S. patent application Ser. No. 11/729,075, entitled “Integrated Sensors for Tracking Performance Metrics” and filed on Mar. 27, 2007, which is incorporated by reference herein in its entirety.

While the embodiment shown in FIG. 1 includes camera 111, microphone 112, thermometer 113, hygrometer 114, motion sensing component 115, positioning circuitry 116, and physiological sensing component 117; it is understood that any other suitable sensor or circuitry can be included in sensors 110. For example, sensors 110 may include a magnetometer or a proximity sensor in some embodiments.

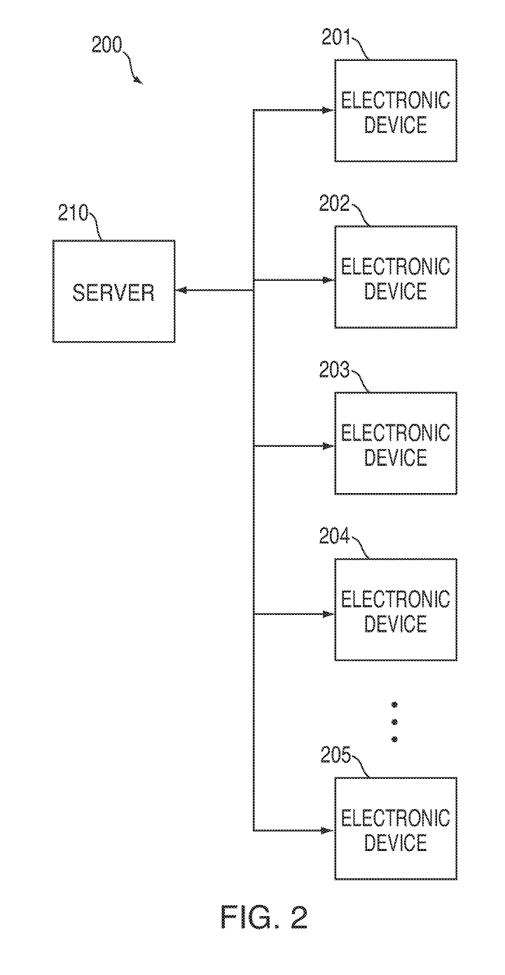

As previously described, a system for controlling an audio and visual experience can include multiple devices. For example, monitoring the environment can include receiving signals from several devices in a network and then one or more devices can be used to control the audio and visual experience. FIG. 2 is a schematic view of system 200 for controlling an audio and video experience in accordance with one embodiment of the invention. System 200 may include electronic devices 201-205. Electric devices 201-205 may include any suitable devices for monitoring an environment (see, e.g., device 100). Electronic devices 201-205 may communicate together using any suitable communications protocol. For example, devices 201-205 may communicate using any protocol supported by communications circuitry in each of devices 201-205 (see, e.g., communications circuitry 105 in device 100). Devices 201-205 may communicate using a protocol such as, for example, Wi-Fi (e.g., a 802.11 protocol), Bluetooth®, radio frequency systems (e.g., 900 MHz, 1.4 GHz, and 5.6 GHz communication systems), cellular networks (e.g., GSM, AMPS, GPRS, CDMA, EV-DO, EDGE, 3GSM, DECT, IS-136/TDMA, iDen, LTE or any other suitable cellular network or protocol), infrared, TCP/IP (e.g., any of the protocols used in each of the TCP/IP layers), HTTP, BitTorrent, FTP, RTP, RTSP, SSH, Voice over IP (VOIP), any other communications protocol, or any combination thereof. In some embodiments, an electronic device may monitor an environment by receiving signals from one or more other electronic devices. For example, electronic device 201 may monitor an environment by receiving signals from devices 202-205.

In some embodiments, an electronic device may monitor an environment through the output of sensors located within the environment. For example, each of devices 202-205 may include a sensor and electronic device 201 may monitor an environment by receiving signals from devices 202-205 representing the output of those sensors. In such an example, electronic device 201 may then control an audio and visual experience based on the collective monitoring of the environment.

In some embodiments, an electronic device may monitor an environment by determining the number of other devices located within the environment. In some embodiments, electronic device 201 may use a short-range communications protocol (e.g., Bluetooth) to receive signals from devices 202-205 indicating the number of other devices in its environment. For example, device 201 may transmit a query and all devices in the environment that receive the query (e.g., devices 202-205) may transmit signal in response. Continuing the example, device 201 may receive the response signals and use the receiving signal to determine the number of discoverable devices within range and, therefore, within the environment. The number of other devices located within the environment may then be used to estimate the number of people within the environment. For example, electronic device 201 may then control an audio and visual experience based on the number of other devices, and presumably people, in the environment.

In some embodiments, an electronic device may monitor an environment by determining the music libraries or user preference stored on other devices located within the environment. For example, electronic devices 202-205 may store music libraries (e.g., in storage or memory) and electronic device 201 may receive signals from devices 202-205 representing the contents of those libraries. In such an example, electronic device 201 may then control an audio and visual experience based on the music libraries of the environment's occupants (e.g., users whose devices are within the environment). Such an exemplary use can also apply to user preferences (e.g., favorite genres or previous song ratings) stored on other devices located within the environment.

A system for controlling an audio and visual experience may include a server. In some embodiments, a server may facilitate communications amongst devices. For example, system 200 may include server 210 for facilitating communications amongst devices 201-205. Server 210 may include any suitable device or computer for communicating with electronic devices 201-205. For example, server 210 may include an internet server for communicating with electronic devices 220-224. Server 210 and electronic devices 201-205 may communicate together using any suitable communications protocol. In some embodiments, a server may provide information about an environment. For example, system 200 may include server 210 for hosting a website (e.g., a social networking website) and server 210 may transmit signals to device 201 representing information about an environment that is collected from the website. In such an example, electronic device 201 may then control an audio and visual experience based on the information about the environment (e.g., which website members are in the environment or the mood of the website members that are in the environment).

While the embodiment shown in FIG. 2 includes server 210, it is understood that electronic devices 201-205 may communicate amongst each other without using a server in some embodiments. For example, devices 201-205 may form a peer-to-peer network that does not require a server.

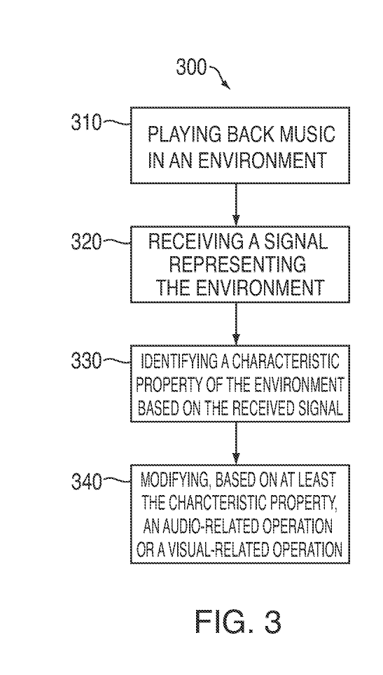

FIG. 3 is a flowchart of illustrative process 300 for controlling an audio and visual experience in accordance with one embodiment of the invention. Process 300 can be performed by a single device (e.g., device 100 or one of devices 201-205), multiple devices (e.g., two of devices 201-205), a server and a device (e.g., server 210 and one of devices 201-205), or any suitable combination of servers and devices. Process 300 can begin at block 310.

At block 310, music can be played back in an environment. The music can be played back by any suitable device (see, e.g., device 100 or devices 201-205). Music played back at block 310 can be part of a song, a music video, or any other suitable audio and/or visual recording. The music can be played back through input/output circuitry in a device (see, e.g., input/output circuitry 104 in device 100). For example, the music can be played back through one or more speakers integrated into the device, one or more speakers coupled with the device, headphones coupled with the device, any other suitable input/output circuitry, or any combination thereof.

At block 320, a signal can be received representing an environment. For example, a device can receive a signal representing the environment in which the music is played back. The signal can represent the environment in any suitable way. For example, the signal can be the output of a sensor exposed to the environment. In some embodiments, the signal can be received from a sensor or circuitry within the device playing back music. For example, a device can play back music and then receive a signal from an integrated sensor (e.g., one of sensors 110 in device 100).

In some embodiments, the signal can be received from another device in the environment. For example, a device can play back music and then receive a signal from another device (e.g., device 201 can receive a signal from one of devices 202-205). A signal received from another device can represent the environment by, for example, representing the output of a sensor in the other device. In another example, a signal received from another device can represent the environment by including information about the other device's music library.

At block 330, a characteristic property of the environment can be identified based on the received signal. As previously described, a characteristic property can be any suitable property of the environment or any combination thereof. For example, the characteristic property can be related to an ambient property of the environment (e.g., light or sounds) or the environment's occupants (e.g., number of people nearby or characteristics of people nearby). Any suitable technique can be used to identify a characteristic property. In some embodiments, identifying a characteristic property may include converting a received analog signal to a digital signal (see, e.g., input/output circuitry 104 of device 100). For example, a signal received from an analog sensor may be converted to a digital signal as part of identifying a characteristic property. In some embodiments, identifying a characteristic property may include measuring the value of a signal received from a sensor. For example, the value of a sensor output (e.g., the resistance across the outputs of a light detector) may directly represent a characteristic property of the environment (e.g., ambient light). In some embodiments, identifying a characteristic property may include performing one or more signal processing operations on a received signal. Any suitable signal processing operation can be performed on a received signal such as, for example, filtering, adaptive filtering, feature extraction, spectrum analysis, any other suitable signal processing operation, or any combination thereof. In some embodiments, a received signal may be filtered to remove any noise or sensor artifacts in the received signal. For example, a sensor output may be processed by a low-pass filter to generate an average value of the sensor output that can serve as a characteristic property. In some embodiments, a received signal may undergo signal processing to remove any portion of a received signal resulting from music playback. For example, a signal received from a microphone may include portions resulting from the sound of music playback or a signal received from a motion sensing component may include portions resulting from the vibrations of speakers playing back music. Accordingly, a received signal may undergo signal processing to minimize the impact that any such portions can have on a characteristic property of the environment. In some embodiments, a received signal may undergo spectrum analysis to determine the composition of the signal. For example, the frequency composition of a sensor output may be analyzed to determine a characteristic property. In some embodiments, identifying a characteristic property may include extracting one or more features from a received signal. For example, a received signal may include a digital image (e.g., output from camera 111), and the image may undergo feature extraction to identify any edges, corners, blobs, or other suitable features that may represent a characteristic property. In one exemplary embodiment, an image of an environment can be analyzed to determine the number of blobs in the image, and that number may be representative of the number of people within the environment.

At block 340, an audio-related operation or a visual-related operation can be modified based on at least the characteristic property. Any device, component within a device, or other portion of a system can modify its operation at block 340. For example, a device that plays back music (see, e.g., block 310) can modify its operation based on at least the characteristic property. By modifying its operation based on the characteristic property, a system can control an audio and visual experience based on the environment. In some embodiments, a system can modify its operation based on a characteristic property at a particular time (e.g., an instantaneous value of a characteristic property). For example, a system can modify its operation based on the level of ambient light at a particular time. In some embodiments, a system can modify its operation in response to a change in a characteristic property. For example, a system may monitor a characteristic property over time and then modify its operation if the characteristic property changes substantially. In some embodiments, process 300 may include a calibration step. For example, prior to playing back music (see, e.g., block 310), an input representing the environment can be received and a characteristic property of the environment can be identified. The characteristic property identified prior to playing back music may then be used as a baseline for comparison with characteristic properties identified at a later point in time.

As previously described, an audio-related operation or visual-related operation can be modified in any suitable manner based on the characteristic property of the environment. In some embodiments, either an audio-related operation or a visual-related operation can be modified based on the characteristic property but, in other embodiments, both an audio-related operation and a visual-related operation can be modified based on the characteristic property. The operation of the system can be modified to control an audio and visual experience based on the characteristic property. For example, a system can modify its operation by providing a visualization of music, selecting songs for playback, controlling an audio and video experience in any other suitable manner, or any combination thereof.

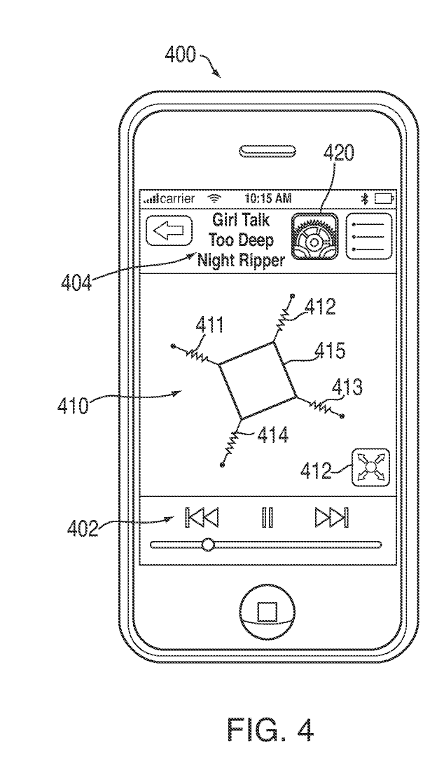

In some embodiments, a visualization of music that is based at least partially on a characteristic property of an environment can be provided. For example, one or more features of a visualization (e.g., color or speed) may be adjusted based on a characteristic property of an environment. FIG. 4 is a schematic view of an illustrative display for providing a visualization of music in accordance with one embodiment. Screen 400 can be provided by an electronic device (e.g., device 100 or one of devices 201-205). In some embodiments, screen 400 or a portion thereof can be provided through one or more external displays coupled with an electronic device (e.g., displays coupled with device 100 through input/output circuitry 104). In the following description, display screen 400, and other display screens, will be described as being provided on a touch screen so that a user can provide an input by directly touching virtual buttons on the screen, although any suitable screen and input mechanism combination could be used in accordance with the disclosure. The electronic device can provide screen 400 during music playback.

Screen 400 can include visualizer 410. Visualizer 410 can be a visualization of music. Visualizer 410 can represent music played back by a device in a system (see, e.g., device 100). In some embodiments, visualizer 410 can represent music played back by the same electronic device that is providing screen 400. Visualizer 410 can provide animated imagery of any style and including any suitable shapes or colors for visually representing music. In some embodiments, imagery provided by visualizer 410 can include one or more elements based at least partially on music. For example, visualizer 410 can provide imagery that includes elements 411-415, and each of elements 411-415 can represent a different portion of music (e.g., different parts in a quartet). Elements provided through visualizer 410 can have a size, shape, or color based at least partially on music. For example, a relatively large element may be used to represent relatively loud music. In another example, a relatively bright element may be used to represent relatively bright (e.g., upbeat or high-pitched) music. Elements provided through visualizer 410 can move based on music (e.g., synchronized with music). For example, elements may move relatively quickly to represent relatively fast-paced music. Elements provided through visualizer 410 can include three-dimensional effects based on music. For example, elements may include shadows or reflections to represent relatively loud music. In some embodiments, visualizer 410 can include a visualizer similar in general appearance, but not operation, to the visualizer provided as part of the iTunes® software distributed by Apple Inc., of Cupertino, Calif.

However, unlike a traditional visualizer, a visualizer in accordance with the disclosure may operate based at least partially on an environment. For example, visualizer 410 may provide imagery with one or more features based at least partially on the environment. Any suitable feature of a visualization can be based on the environment such as, for example, the number of elements, the size of each element, the color palette (e.g., the color of each element or the color of the background), the location of each element, the form in which each element moves, the speed at which each element moves, any other suitable feature of a visualization or any combination thereof. In some embodiments, a system may identify a characteristic property of an environment (see, e.g., block 330 of process 300), and a visualizer may provide imagery with one or more features based at least partially on the characteristic property (see, e.g., block 340 of process 300 in which a system modifies its operation based on a characteristic property). For example, one or more features of the visualization provided by visualizer 410 may be based at least partially on a characteristic property of an environment.

In some embodiments, a visualizer can be provided in full-screen mode. For example, all controls, indicators, and options may be hidden when a visualizer is provided in full-screen mode. While the embodiment shown in FIG. 4 is not in full-screen mode, screen 400 can include option 412 for providing visualizer 410 in full-screen mode.

In some embodiments, a screen for providing a visualization of music can include controls for controlling playback of music. For example, screen 400 can include controls 402 for controlling the playback of music. Controls can include any suitable controls for controlling the playback of music (e.g., pause, fast forward, and rewind).

In some embodiments, a screen for providing a visualization of music can include indicators representing the music. For example, screen 400 can include indicators 404 for representing the music. Indicators can provide any suitable information about the music (e.g., artist, title, and album).

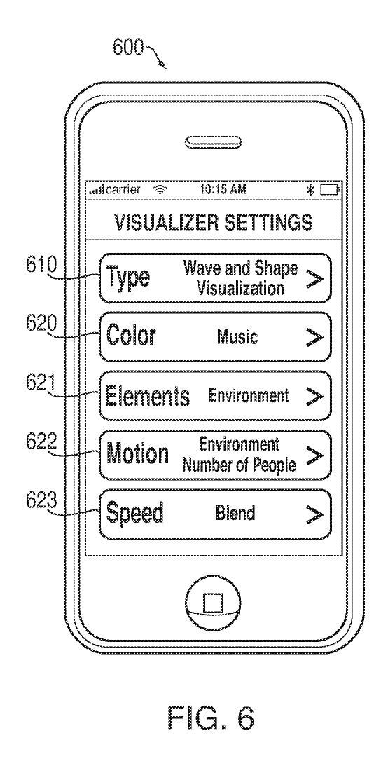

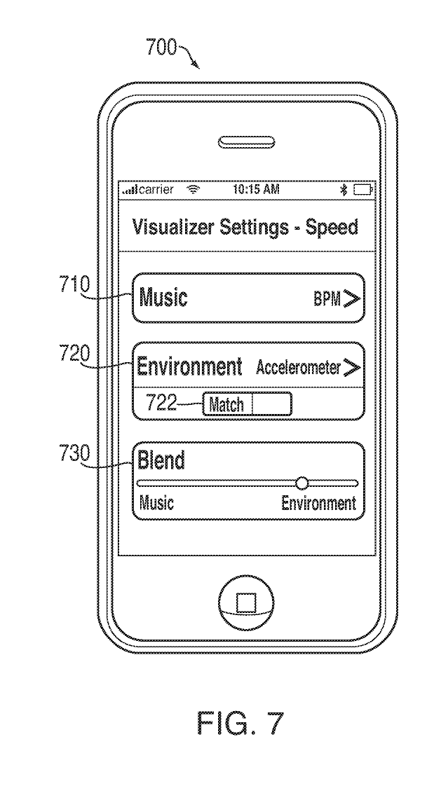

In some embodiments, a screen for providing a visualization of music can include a configuration option. For example, screen 400 can include configuration option 420. A user may select a configuration option to access a screen for configuring a system to provide a visualization of music. For example, a user may select configuration option 420 to access a screen for configuring visualizer 410. A more detailed description of screens for configuring a system to provide a visualization of music can be found below, for example, in connection with FIGS. 6 and 7.

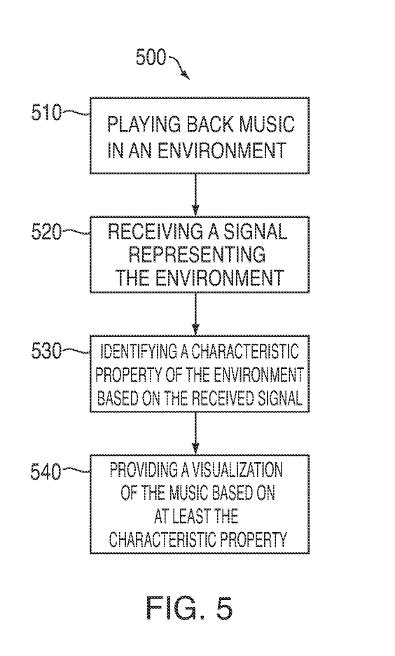

As previously described, providing a visualization of music may be one way in which a system can control an audio and visual experience. For example, a system can provide a visualization of music based on an environment and, thereby, control an audio and visual experience based on the environment. FIG. 5 is a flowchart of illustrative process 500 for providing a visualization of music in accordance with one embodiment of the invention. Process 500 can be performed by a single device (e.g., device 100 or one of devices 201-205), multiple devices (e.g., two of devices 201-205), a server and a device (e.g., server 210 and one of devices 201-205), or any suitable combination of servers and devices. Process 500 can begin with blocks 510, 520, and 530.

At block 510, music can be played back in an environment. At block 520, a signal representing the environment can be received. At block 530, a characteristic property of the environment can be identified based on the received signal. Blocks 510, 520, and 530 can be substantially similar to blocks 310, 320 and 330 of process 300, and the previous description of the latter can be applied to the former.

At block 540, a visualization of music based on at least the characteristic property can be provided. A feature of a visualization can be based on at least the characteristic property. For example, the number of elements, the size of each element, the color palette (e.g., the color of each element or the color of the background), the location of each element, the form in which each element moves, the speed at which each element moves, any other suitable feature of a visualization or any combination thereof may be based on at least the characteristic property. In some embodiments, multiple features of a visualization can be based on at least one or more characteristic properties. In some embodiments, multiple features of a visualization can be based on a single characteristic property. For example, the number of elements and the speed at which each element moves (i.e., features of a visualization) can be based on the amount of movement in an environment (i.e., a characteristic property). In some embodiments, different features of a visualization can be based on different characteristic properties. For example, the number of elements and the speed at which each element moves can be based on, respectively, the number of people or devices occupying an environment and the amount of movement in an environment (i.e., characteristic properties). In addition to one or more characteristic properties, a visualization provided at block 540 may also be based on the music so that the visualization represents both the music and the environment.

In some embodiments, a user can configure a system to specify how a visualization of music can be provided based on an environment. A user may be able to configure any aspect of monitoring an environment (e.g., identifying a characteristic property of the environment) or providing a visualization of music based on the environment. For example, a user may be able to specify which features of a visualization can be based on the environment. In another example, a user may be able to specify the characteristic properties of the environment on which a visualization can be based. FIG. 6 is a schematic view of an illustrative display for configuring a system to provide a visualization of music in accordance with one embodiment. Screen 600 can be provided by an electronic device (e.g., device 100 or one of devices 201-205). An electronic device can provide screen 600 as part of the device's configuration options. In some embodiments, an electronic device can provide screen 600 when a user accesses visualizer configuration options (see, e.g., option 420 of screen 400).

A configuration screen can include options for controlling a visualizer (see, e.g., visualizer 410). In some embodiments, screen 600 can include option 610 corresponding to a visualization type. For example, a user may set option 610 so that a visualizer provides a certain type of visualization. The choices associated with option 610 may include any suitable type of visualization such as, for example, a shape visualization, a wave visualization (e.g., an oscilloscope visualization), a bar visualization, a wireframe visualization, a strobe visualization, any other suitable type of visualization, and any combination thereof. In the embodiment shown in FIG. 6, option 610 may be set so that a visualizer provides a wave and shape visualization. For example, visualizer 410 may provide a visualization that includes elements 411-414, each of which can be a wave, as well as element 415, which can be a shape.

A configuration screen can include options corresponding to features of a visualization. In some embodiments, screen 600 can include options 621-623 corresponding to features of a visualization. For example, each of options 621-623 can correspond to a feature of a visualization and a user can specify how music or characteristic properties of an environment affect that feature.

In some embodiments, option 620 can correspond to the color palette of a visualization. For example, option 620 can correspond to the color of one or more elements of a visualization, the color of the visualization's background, or any other aspect of a visualization that can be colored. The choices associated with option 620 may include music generally, one or more particular properties of music (e.g., tempo, BPM, or pitch), environment generally, and one or more characteristic properties of an environment (e.g., an ambient property of the environment, such as vibrations or light, or a property based on an environment's occupants, such as the number of people in the environment or the movement of people or devices in the environment). In the embodiment shown in FIG. 6, option 620 may be set so that a visualizer can provide a visualization with a color palette generally based on the music. For example, visualizer 410 may provide a visualization with a color palette generally based on the music.

In some embodiments, option 621 can correspond to the elements of a visualization. For example, option 621 can correspond to the number of elements, the size of elements, or the shape of elements included in a visualization. Like option 620, the choices associated with option 621 may include music generally, one or more particular properties of music, environment generally, and one or more characteristic properties of an environment. In the embodiment shown in FIG. 6, option 621 may be set so that a visualizer can provide a visualization that includes elements generally based on the environment. For example, visualizer 410 may provide a visualization including elements 411-415, the size, shape, and number of which may be generally based on the environment.

In some embodiments, a user selecting the option to generally base one or more features of a visualization on an environment may still involve a system determining one or more characteristic properties of the environment (see, e.g., block 530 of process 500) and providing a visualization based on the one or more characteristic properties (see, e.g., block 540 of process 500). The one or more characteristic properties used in such a situation may include characteristic properties that are generally representative of an environment (e.g., average color or number of people in an environment). In situations where a user may be configuring a system, providing a general option can be advantageous because it may simplify the configuration process from the user's perspective.

While the embodiment shown in FIG. 6 includes option 621 corresponding to elements generally, it is understood that multiple options corresponding to elements can be provided, and each option can correspond to a different element so that each element can be configured independently. For example, separate options can be provided for independently configuring each of elements 411-415 provided by visualizer 410.

In some embodiments, option 622 can correspond to the motion of a visualization. For example, option 622 can correspond to the manner or form in which the elements of a visualization move. Like option 620, the choices associated with option 622 may include music generally, one or more particular properties of music, environment generally, and one or more characteristic properties of an environment. In the embodiment shown in FIG. 6, option 622 may be set so that a visualizer can provide a visualization that includes motion based on the number of people in the environment (i.e., a characteristic property). For example, visualizer 410 may provide a visualization including elements 411-415, and each of elements 411-415 may move in a form based on the number of people in the environment. In an exemplary embodiment, each of elements 411-414 may rotate around element 415 if there is a relatively large number of people in the environment. As previously described, there are a number of suitable techniques for determining or estimating the number of people in an environment (e.g., determining the number of discoverable devices in the environment or determining the number of blobs in an image of the environment), and any suitable technique, or any combination of techniques, can be used to determine the number of people in an environment.

In some embodiments, option 623 can correspond to the speed of a visualization. For example, option 623 can correspond to the speed at which elements of a visualization move. Like option 620, the choices associated with option 623 may include music generally, one or more particular properties of music, environment generally, and one or more characteristic properties of an environment. In the embodiment shown in FIG. 6, option 623 may be set so that a visualizer can provide a visualization that includes elements moving at a speed based on both music and the environment. For example, visualizer 410 may provide a visualization including elements 411-414, and each of elements 411-414 may rotate around element 415 at a speed based on a blend of both music and the environment.

In some embodiments, a more detailed configuration screen may provided in connection with one or more configuration options. For example, a user may be able to select a configuration option (e.g., option 610 or one of options 620-623) and access a detailed configuration screen related to that option. FIG. 7 is a schematic view of an illustrative display for configuring a system to provide a visualization of music in accordance with one embodiment. Screen 700 can be provided by an electronic device (e.g., device 100 or one of devices 201-205). An electronic device can provide screen 700 as part of the device's configuration options. In some embodiments, an electronic device can provide screen 700 when a user accesses a specific visualizer configuration option. For example, a device can provide screen 700 when a user selects option 623 of screen 600.

A detailed configuration screen can include options corresponding to a specific feature of a visualization. For example, screen 700 can include options corresponding to the speed at which one or more elements of a visualization move. Screen 700 can include option 710 for specifying one or more properties of music that can affect the speed at which one or more elements of a visualization move. The choices associated with option 710 may include music generally and one or more particular properties of music (e.g., tempo, BPM, or pitch). In the embodiment shown in FIG. 7, option 710 may be set so that a visualizer can provide a visualization with elements that move based on at least the BPM of the music. For example, visualizer 410 may provide a visualization with elements 411-414 rotating at a speed based on at least the BPM of the music.

Screen 700 can include option 720 for specifying one or more characteristic properties of an environment that can affect the speed at which one or more elements of a visualization move. The choices associated with option 720 may include an environment generally and one or more particular characteristic properties of an environment. As previously described, characteristic properties of an environment can include vibrations, light (e.g., ambient light levels or average color), sound, magnetic fields, temperature, humidity, barometric pressure, the number of people or devices in an environment, the movement of people or devices in an environment, characteristics of people or devices in an environment, any other feature of the environment, or any combination thereof. In the embodiment shown in FIG. 7, option 720 may be set so that a visualizer can provide a visualization with elements that move based on at least the vibrations in an environment. For example, visualizer 410 may provide a visualization with elements 411-414 rotating at a speed based on at least the magnitude or frequency of the vibrations in the environment. In an exemplary embodiment, each of elements 411-414 may rotate around element 415 at a relatively fast speed if there is a relatively large amount of vibrations in the environment.

In some embodiments, screen 700 can include option 722 for specifying how one or more characteristic properties of an environment can affect the speed at which one or more elements of a visualization move. The choices associated with option 722 may include matching and contrasting. For example, a visualization can be provided with one or more features that correlate positively with an environment (e.g., match the environment) or correlate negatively with the environment (e.g., contrast with the environment). In the embodiment shown in FIG. 7, option 722 may be set so that a visualizer can provide a visualization with elements moving at a speed that correlates positively with the vibrations in an environment. For example, visualizer 410 may provide a visualization with elements 411-414 rotating at a speed that generally matches the frequency or magnitude of the vibrations in the environment. In other embodiments, option 722 may be set so that a visualizer can provide a visualization with elements moving at a speed that correlates negatively with the vibrations in an environment. For example, visualizer 410 may provide a visualization with elements 411-414 rotating at a speed that generally contrasts the frequency or magnitude of vibrations in the environment. In an exemplary embodiment, each of elements 411-414 may rotate around element 415 at a relatively fast speed if there is a relatively small amount of vibrations or relatively low frequency vibrations in the environment.

In some embodiments, screen 700 can include option 730 for specifying how music and environment collectively affect a visualization (e.g., how music and environment are blended). For example, option 730 can correspond to the relative weight put on the music and one or more characteristic properties of the environment when providing a visualization. In some embodiments, option 730 can be a slider bar with values ranging from completely music to completely environment, and the value that the slider bar is set to may control how music and environment collectively affect a visualization.

While the embodiment shown in FIG. 7 includes a detailed configuration screen corresponding to the speed of a visualization, it is understood that detailed configuration screen corresponding to other features of a visualization may be provided. Detailed configuration screens corresponding to the color, elements, motion, or any other suitable feature of a visualization may be provided with options similar to the options shown in FIG. 7. For example, a detailed configuration screen corresponding the color of a visualization may be provided and a user may specify whether one or more colors of a visualization matches the environment or contrasts with the environment.

In some embodiments, one or more of the options for providing a visualization may be set randomly. For example, one or more of the options shown in FIG. 6 or FIG. 7 can be associated with a random choice and, if a user selects the random choice, the option may be set randomly. In some embodiments, one or more of the options for providing a visualization may be set dynamically. For example one or more of the options shown in FIG. 6 or FIG. 7 can be associated with a dynamic choice and, if a user selects the dynamic choice, the option may automatically change over time.

While the embodiments shown in FIGS. 6 and 7 include options for visualization features such as color, elements, motion, and speed, configuration options can be provided that correspond to any suitable feature of a visualization. For example, a configuration option can be provided that corresponds to three-dimensional effects of a visualization.

In some embodiments, previously defined option values can be saved by user and later reloaded onto a system. For example, a user may configure a device and then instruct the device to save the values of the configuration options for later use. In this manner, different configurations for providing a visualization of music based on an environment can be created, stored, and reloaded for later use.

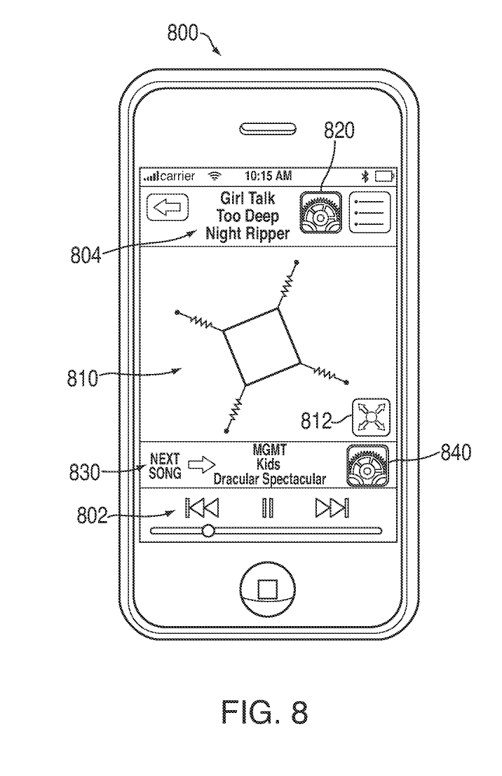

In some embodiments, a piece of music can be selected based at least partially on a characteristic property of an environment. For example, a song can be selected based on a characteristic property of an environment. FIG. 8 is a schematic view of an illustrative display for selecting a piece of music in accordance with one embodiment. Screen 800 can be provided by an electronic device (e.g., device 100 or one of devices 201-205). In some embodiments, screen 800 or a portion thereof can be provided through one or more external displays coupled with an electronic device (e.g., displays coupled with device 100 through input/output circuitry 104). The electronic device can provide screen 800 during music playback.

Screen 800 can controls and indicators related to playback. For example, screen 800 may include controls 802 and indicators 804. Screen 800 can also include a visualization of music and options related to the visualization. For example, screen 800 can include visualizer 810, full-screen option 812, and configuration option 820. Controls 802, indicators 804, visualizer 810, full-screen option 812, and configuration option 820 can be substantially similar to controls 402, indicators 404, visualizer 410, full-screen option 412, and configuration option 420 of screen 400 and the previous description of the latter can be applied to the former.

In some embodiments, a system can have access to a library of music. For example, a device in a system (e.g., device 100 or one of devices 201-205) can store a library of music in storage or memory (see, e.g., storage 102 or memory 103). In another example, a server in a system (e.g., server 210) can store a library of music in storage or memory (see, e.g., storage 102 or memory 103). In some embodiments, a library of music may include metadata associated the music. For example, a library of music may include metadata representing any suitable feature of the music such as, for example, title, artist, album, year, track, genre, loudness, speed, BPM, energy level, user rating, playback history, any other suitable feature, or any combination thereof. A system with access to a music library can use metadata to select one or more pieces of music from the library and play them back in an environment. For example, a system can select a song from the library based on artist metadata and play it back through one or more speakers (see, e.g., block 310 of process 300).

In some embodiments, a system may control an audio and visual experience by selecting a piece of music based on an environment. For example, a system may select a piece of music based on a characteristic property of an environment. In some embodiments, a system may select a piece of music by identifying a characteristic property of the environment (see, e.g., block 330 of process 300), and then selecting a song with metadata appropriate for the characteristic property. For example, if the characteristic property indicates that there is relatively little movement in an environment, a system may select a piece of music with speed or loudness metadata suggesting that the piece is relaxing. Screen 800 can include control 830 for selecting a song based at least partially on an environment. A user can select control 830 to instruct a system to select a song based at least partially on an environment. For example, a system can select a song with metadata appropriate for one or more characteristic properties of an environment.

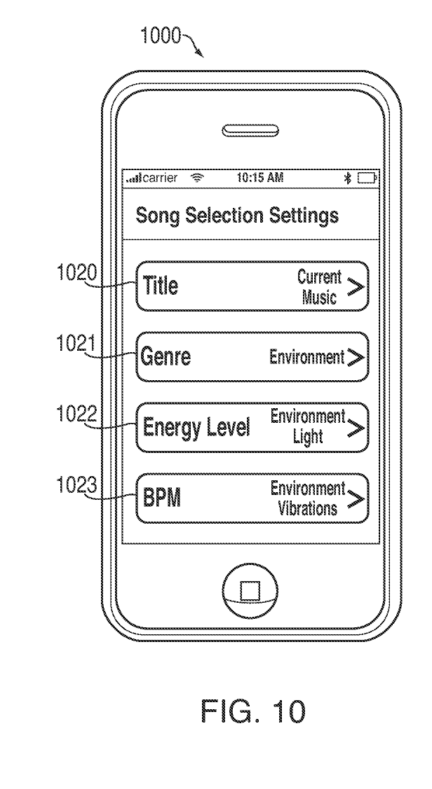

In some embodiments, a screen that includes a control for selecting a piece of music based at least partially on an environment can include a configuration option. For example, screen 800 can include configuration option 840. A user may select a configuration option to access a screen for configuring a system to select a piece of music. For example, a user may select configuration option 840 to access a screen for configuring how a song is selected if control 830 is selected. A more detailed description of screens for configuring a system to select a piece of music can be found below, for example, in connection with FIG. 10.

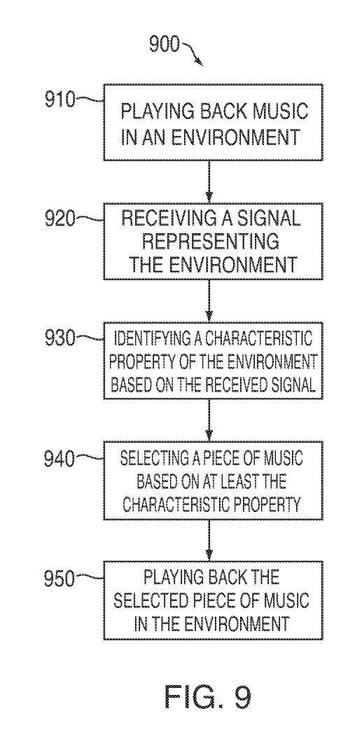

As previously described, selecting a piece of music and playing back that music may be one way in which a system can control an audio and visual experience. For example, a system can select and play back a piece of music based on an environment and, thereby, control an audio and visual experience based on the environment. FIG. 9 is a flowchart of illustrative process 900 for selecting a piece of music in accordance with one embodiment of the invention. Process 900 can be performed by a single device (e.g., device 100 or one of devices 201-205), multiple devices (e.g., two of devices 201-205), a server and a device (e.g., server 210 and one of devices 201-205), or any suitable combination of servers and devices. Process 900 can begin with blocks 910, 920, and 930.

At block 910, music can be played back in an environment. At block 920, a signal representing the environment can be received. At block 930, a characteristic property of the environment can be identified based on the received signal. Blocks 910, 920, and 930 can be substantially similar to blocks 310, 320 and 330 of process 300, and the previous description of the latter can be applied to the former.

At block 940, a piece of music can be selected based on at least the characteristic property. In some embodiments, selecting a piece of music can include searching a collection of music. For example, a system can search an entire library of music or a limited playlist of music (e.g., a dance-party playlist). In some embodiments, selecting a piece of music can include accessing metadata associated with the collection of music. For example, a system can search the metadata associated with a collection of music to find a piece of music with metadata appropriate for the characteristic property. Selecting a piece of music can include accessing any suitable type of metadata such as, for example, title metadata, artist metadata, album metadata, year metadata, track metadata, genre metadata, loudness metadata, speed metadata, BPM metadata, energy level metadata, user rating metadata, playback history metadata, any other suitable metadata, or any combination thereof. In some embodiments, selecting a piece of music based on at least the characteristic property can include identifying a range of metadata values that is appropriate for the characteristic property and selecting a piece of music that falls within that range. For example, if a characteristic property indicates that there is a relatively large number of people in an environment, a system may search for a piece of music with genre metadata that is dance, rock and roll, hip hop, or any other genre appropriate for large parties. In another example, if a characteristic property indicates that the average heart rate of users in the environment is relatively high, a system may search for a piece of music with BPM metadata having a value between 110 BPM and 130 BPM.

In some embodiments, the music libraries of an environment's occupants can be a characteristic property of the environment. For example, selecting a piece of music based on at least a characteristic property can include searching the music libraries of an environment's occupants. In some embodiments, a system can search the music libraries of an environment's occupants and then select a piece of music similar to the music in the libraries. In some embodiments, a system can search the music libraries of an environment's occupants and then select a piece of music contained in one or more of the libraries.

In some embodiments, a system can select a piece of music based on both the environment and other features of the music. For example, selecting a piece of music can include searching a collection for music based on at least one non-environmental feature of the music. In some embodiments, a system can select a piece of music based on music that is currently being played back or was previously played back. For example, a system may select a piece of music that is both similar to music that is currently being played back and appropriate for the environment.

At block 950, the selected piece of music can be played back in the environment. For example, the selected piece of music can be played back in the same manner that music is played back in block 910 (see, e.g., block 310 of process 300).

In some embodiments, a user can configure a system to select a piece of music based on an environment. A user may be able to configure any aspect of monitoring an environment (e.g., identifying a characteristic property of the environment) or selecting a piece of music based on the environment. For example, a user may be able to specify which type of metadata can be searched based on the environment. In another example, a user may be able to specify the characteristic properties of the environment on which a music selection can be based. FIG. 10 is a schematic view of an illustrative display for configuring a system to select a piece of music in accordance with one embodiment. Screen 1000 can be provided by an electronic device (e.g., device 100 or one of devices 201-205). An electronic device can provide screen 1000 as part of the device's configuration options. In some embodiments, an electronic device can provide screen 1000 when a user accesses song selection configuration options (see, e.g., option 840 of screen 800).

A configuration screen can include options for controlling song selection. For example, screen 1000 can include options for controlling how a song is selected in response to a user selecting control 830 of screen 800. In some embodiments, a configuration screen can include options corresponding to types of metadata that may affect music selection. For example, screen 600 can include options 1020-1023 corresponding to types of metadata. In some embodiments, each of options 1020-1023 can correspond to a type of metadata and a user can specify how to search for music using that type of metadata and characteristic properties of an environment.

In some embodiments, option 1020 can correspond to title metadata. For example, a user may set option 1020 so that selecting a song includes searching title metadata based on current music or one or more characteristic properties. The choices associated with option 1020 may include current music, environment generally, and one or more characteristic properties of an environment (e.g., an ambient property of the environment, such as vibrations or light, or a property based on an environment's occupants, such as the number of people in the environment or the movement of people or devices in the environment). In the embodiment shown in FIG. 10, option 1020 may be set so that title metadata is searched to identify pieces of music similar to the music currently being played back (e.g., music played back at block 910). In some embodiments, finding music similar to the music being currently played back may include accessing a database of music comparisons. For example, finding similar music may include accessing a database in a manner similar to the Genius feature provided as part of the iTunes® software distributed by Apple Inc., of Cupertino, Calif.

In some embodiments, option 1021 can correspond to genre metadata. For example, a user may set option 1021 so that selecting a song includes searching genre metadata based on current music or one or more characteristic properties. Like option 1020, the choices associated with option 1021 may include current music, environment generally, and one or more characteristic properties of an environment. In the embodiment shown in FIG. 10, option 1021 may be set so that genre metadata is searched to identify pieces of music with a genre generally appropriate for the environment. For example, if an environment is generally relaxing (e.g., few people and little movement), a system may select a piece of music with a relaxing genre (e.g., smooth jazz).

In some embodiments, a user selecting the option to generally base a music selection on an environment may still involve a system determining one or more characteristic properties of the environment (see, e.g., block 930 of process 900) and selecting a piece of music based on the one or more characteristic properties (see, e.g., block 940 of process 900). The one or more characteristic properties used in such a situation may include characteristic properties that are generally representative of an environment (e.g., average color or number of people in an environment). In situations where a user may be configuring a system, providing a general option can be advantageous because it may simplify the configuration process from the user's perspective.

In some embodiments, option 1022 can correspond to energy level metadata. For example, a user may set option 1022 so that selecting a song includes searching energy level metadata based on current music or one or more characteristic properties. Like option 1020, the choices associated with option 1022 may include current music, environment generally, and one or more characteristic properties of an environment. In the embodiment shown in FIG. 10, option 1022 may be set so that energy metadata is searched to identify pieces of music with an energy level generally appropriate for the light in an environment (i.e., a characteristic property). For example, if the light in an environment is generally bright, a system may select a piece of music with a relatively high energy level (e.g., rock and roll).

In some embodiments, option 1023 can correspond to BPM metadata. For example, a user may set option 1023 so that selecting a song includes searching BPM metadata based on current music or one or more characteristic properties. Like option 1023, the choices associated with option 1022 may include current music, environment generally, and one or more characteristic properties of an environment. In the embodiment shown in FIG. 10, option 1023 may be set so that BPM metadata is searched to identify pieces of music with a BPM value generally appropriate for the vibrations in an environment (i.e., a characteristic property). For example, if there are high frequency vibrations in an environment, a system may select a piece of music with a relatively high BPM (e.g., music with a BPM value that is similar to the dominant frequency of the vibrations).

In some embodiments, a detailed configuration screen can be provided in connection with one or more configuration options for selecting a piece of music. For example, a user may be able to select a configuration option (e.g., one of options 1020-1023) and access a detailed configuration screen related to that option. A detailed configuration screen can include options for specifying certain characteristic properties or blends of current music and characteristic properties (see, e.g., screen 700).

In some embodiments, previously defined option values can be saved by user and later reloaded onto a system. For example, a user may configure a device and then instruct the device to save the values of the configuration options for later use. In this manner, different configurations for selecting a piece of music can be created, stored, and reloaded for later use.

While the embodiment shown in FIG. 10 includes options for selecting a piece of music based on title metadata, genre metadata, energy level metadata, and BPM metadata, it is understood that music selection can be Performed using any other type of metadata and characteristic properties of an environment.

The various embodiments of the invention may be implemented by software, but can also be implemented in hardware or a combination of hardware and software. The invention can also be embodied as computer readable code on a computer readable medium. The computer readable medium can be any data storage device that can store data which can thereafter be read by a computer system. Examples of a computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

The above described embodiments of the invention are presented for purposes of illustration and not of limitation, and the present invention is limited only by the claims which follow.

What is claimed is:

1. A method for controlling an audio and visual display, the method comprising:
playing back music in an environment;
receiving signals representing the environment from a plurality of devices;
identifying a characteristic property of the environment based on the received signals; and
modifying, based on at least the characteristic property, at least one of an audio-related operation and a visual-related operation.

2. The method of claim 1, wherein:
the receiving signals comprises receiving output signals from sensors exposed to the environment; and
two or more of the sensors are provided in different devices.

3. The method of claim 1, wherein:
the receiving signals comprises receiving signals from two or more discoverable devices in the environment; and
the identifying the characteristic property of the environment comprises determining the number of discoverable devices in the environment.

4. The method of claim 1, wherein the characteristic property is related to an ambient property of the environment.

5. The method of claim 1, wherein the characteristic property is related to the environment's occupants.

6. The method of claim 1, wherein the characteristic property is related to a physiological metric of one of the environment's occupants.

7. The method of claim 1, wherein the characteristic property is related to an amount of movement in the environment.

8. The method of claim 1, wherein the characteristic property is related to a music library stored on one of the plurality of devices.

9. The method of claim 1, wherein identifying a characteristic property of the environment comprises:
removing any portion of the received signals resulting from the playing back of the music in the environment.

10. The method of claim 1, wherein modifying at least one of an audio-related operation and a visual-related operation comprises:
providing an audio and visual experience appropriate for the environment.

11. The method of claim 10, wherein the audio visual experience includes the music played back in the environment.

12. A system for controlling an audio and visual display, the system comprising:
input/output circuitry operative to play back music in an environment;
communications circuitry operative to receive signals representing the environment from a plurality of devices; and
control circuitry coupled with the input/output circuitry and communications circuitry and operative to:
identify a characteristic property of the environment based on the received signals; and
modify, based on at least the characteristic property, at least one of an audio-related operation and a visual-related operation.

13. The system of claim 12, wherein the input/output circuitry comprises a speaker operative to play back music in the environment.

14. The system of claim 12, further comprising:
a sensor coupled with the control circuitry and operative to generate a sensor output, wherein the control circuitry is operative to identify the characteristic property based at least partially on the sensor output.

15. The system of claim 14, wherein the sensor comprises a sensor from the group consisting of:
a camera;
a microphone;
a thermometer;
a hygrometer;
a motion sensing component;
positioning circuitry; and
a physiological sensing component.

16. The system of claim 12, further comprising:
a display coupled with the control circuitry and operative to display a visualization of music, wherein the control circuitry is operative to provide a visualization of the music through the display based on at least the characteristic property.

17. The system of claim 12, further comprising:
storage coupled with the control circuitry and operative to store a music library that includes pieces of music and metadata associated with the pieces of music, wherein the control circuitry is operative to select a piece of music based on the metadata and the characteristic property.

18. A method for providing a visualization of music, the method comprising:
playing back music in an environment;
receiving a signal representing the environment;
identifying a characteristic property of the environment based on the received signal; and
providing a visualization of the music based on at least the characteristic property.

19. The method of claim 18, wherein the providing the visualization comprises:
providing a visualization that includes a plurality of elements, an aspect of one or more of the plurality of elements being based on at least the characteristic property.

20. The method of claim 18, wherein providing the visualization comprises:
providing a visualization that includes one or more colors, the colors being based on at least the characteristic property.

21. A method for selecting a piece of music, the method comprising:
playing back music in an environment;
receiving a signal representing the environment;
identifying a characteristic property of the environment based on the received signal;
selecting a piece of music based on at least the characteristic property; and
playing back the selected piece of music in the environment.

22. The method of claim 21, wherein the selecting the piece of music comprises:
searching a collection of music for pieces of music with metadata appropriate for the characteristic property.

23. The method of claim 21, wherein the selecting the piece of music comprises:
selecting the piece of music based on at least the music played back in the environment.

24. The method of claim 21, wherein:
the receiving the signal comprises receiving a signal that represents a music library of an occupant of the environment; and
the identifying the characteristic property comprises identifying the characteristic property based on the accessed music library.

25. A computer readable medium for an electronic device, the computer readable medium comprising:
a first instruction code for playing back music in an environment;
a second instruction code for receiving signals representing the environment from a plurality of devices;
a third instruction code for identifying a characteristic property of the environment based on the received signals; and
a fourth instruction code for modifying, based on at least the characteristic property, at least one of an audio-related operation and a visual-related operation.
